(19) United States
(12) Patent Application Publication
(10) Pub. No.: US 2008/0169916 A1
(43) Pub. Date: Jul. 17, 2008

(54) Reminder for Safety Belt

(76) Inventor: Kee-Weng Lai, Taipei City (TW)

Correspondence Address: WPAT, PC, 7225 BEVERLY ST., ANNANDALE, VA, 22003, US

(21) Appl. No.: 11/697,778

(22) Filed: Apr. 9, 2007

Related U.S. Application Data
(60) Provisional application No. 60/884,652, filed on Jan. 12, 2007.

(51) Int. Cl. B60Q 1/00

(52) U.S. Cl. 340/457.1

(57) ABSTRACT

A vehicle safety belt warning device which comprises a sensing member and a warning member electrically coupled to the sensing member. The sensing member comprises a magnetic element installed on a first buckle member of the vehicle safety belt buckle set and a magnetically-activated control element installed on a second buckle member of the vehicle safety belt buckle set. When the first buckle member and the second buckle member are not engaged, the warning member gives off a warning signal in the form of sound, light or combination thereof.

### BACKGROUND OF THE INVENTION

1. Field of the Invention

The present invention generally relates to a warning device, especially to a vehicle safety belt warning device.

2. Description of the Prior Art

Many people are killed in car accidents due to failure to use the safety belt. However, it is widely recognized that seat belt systems with which most vehicles presently in use are equipped are often not used. People either find it inconvenient or troublesome to repeatedly fasten and unfasten themselves, or they find them uncomfortable or somewhat restrictive of movement with the safety belt fastened.

Another important cause of failure to use the safety belt is the unawareness of not being buckled up due to distractions such as answering phone calls, talking to other occupants, or being busy putting away food or drinks that were just bought.

Therefore, it is desirable to provide for real-time alarm to bring to the occupant's attention to fasten the safety belt, so as to avoid unnecessary death in a car accident.

### SUMMARY OF THE INVENTION

According to the above, the present invention provides a vehicle safety belt warning device fulfill the requirements of the industry.

One object of the present invention is to provide a vehicle safety belt warning device which comprises a sensing member and a warning member electrically coupled to the sensing member. The sensing member comprises a magnetic element installed on a first buckle member of the vehicle safety belt buckle set, and a magnetically-activated control element installed on a second buckle member of the vehicle safety belt buckle set.

When the first buckle member and the second buckle member are not engaged, the warning member gives off a warning signal in the form of sound, light or combination thereof. When the first and second buckle members are engaged, the magnetically-activated control element senses the magnetic field produced by the magnetic element and switches off the warning member.

Another object of the present invention is to provide a vehicle safety belt warning device, the provided warning device comprises a first magnetic element which is installed on the vehicle door; a second magnetic element which is disposed within the interior of the vehicle and in a position corresponding to the first magnetic element; a warning member which is electrically coupled to the second magnetic element; and a power supply member which is electrically coupled to the warning member. Either the first and second magnetic element may be a magnetically-activated control device. When the vehicle door is closed, the magnetically-activated control device senses the magnetic field produced by the magnetic element and activates the warning member to give off a warning signal which may be in the form of sound, light or combination thereof.

### BRIEF DESCRIPTION OF THE DRAWINGS

FIG. 1 is an illustration of a warning device in accordance with an embodiment of the present invention;

FIG. 2 is an illustration of a warning device in accordance with a preferred example of the present invention;

FIG. 3 is an illustration of how a warning device in accordance with another preferred example of the present invention is used with the vehicle safety belt buckle set; and

FIG. 4 is an illustration of a warning device in accordance with yet another preferred example of the present invention;

### DESCRIPTION OF THE PREFERRED EMBODIMENTS

According to the above-mentioned desirability of providing real-time alarm for the vehicle safety melt system, the present invention provides a warning device which may be directly adapted to the conventional vehicle safety belt buckle set which comprises a first buckle member and a second buckle member for engaging with the first buckle member to restrain an occupant in a vehicle for safety purpose.

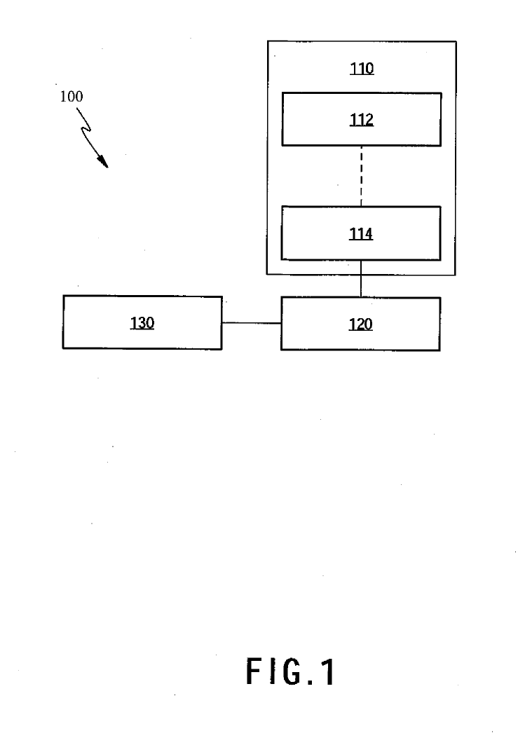

Referring to FIG. 1, in one embodiment of the present invention, the provided warning device 100 comprises a sensing member 110 and a warning member 120 electrically coupled to the sensing member 110. The provided warning device 100 may also comprise a power supply member 130, electrically coupled to the warning member 120, for providing power to the provided warning device 100.

The sensing member 113 comprises a magnetic element 112 and a magnetically-activated control element 114 electrically coupled to the warning member 120, wherein when the magnetically-activated control element 114 does not sense the magnetic field produced by the magnetic element 112, the magnetically-activated control element, 114 activates the warning member 120 to give off a warning signal which may be in the form of sound, light or combination thereof. On the other hand, when the magnetically-activated control element 114 senses the magnetic field produced by the magnetic element 112, the magnetically-activated control element 114 switches off the warning member 120.

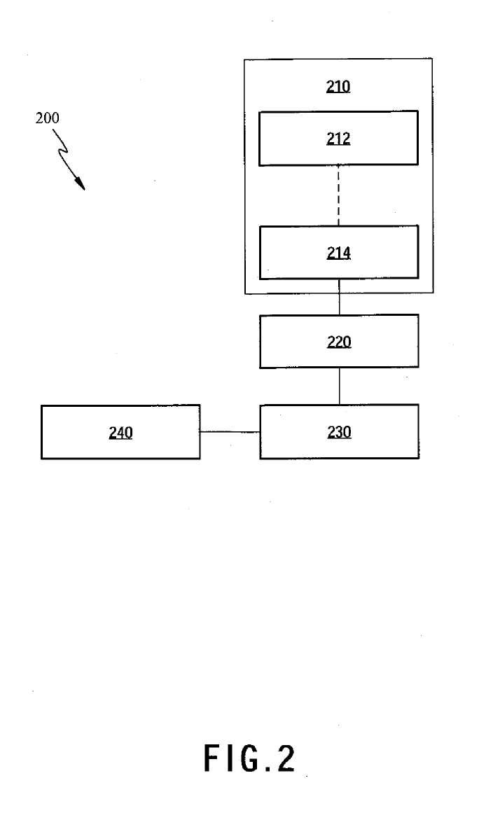

Referring to FIG. 2, in one preferred example of the above embodiment, the provided warning device 200 further comprises a control member 220 electrically coupled to the magnetically-activated control element 214 and the warning member 230 for setting up the frequency at which the warning signals are given off and time interval between individual batches of the warning signals.

For instance, the control member 220 may set the warning member 230 to give off the warning signal at a specific frequency for a few seconds, and then shut off for another few seconds before giving off the subsequent batch of warning signals. The controls member 220 may further comprise a sound recording member (not shown) electrically coupled to the control member 220 to provide a sound recording function, thereby allowing for customized warning signals.

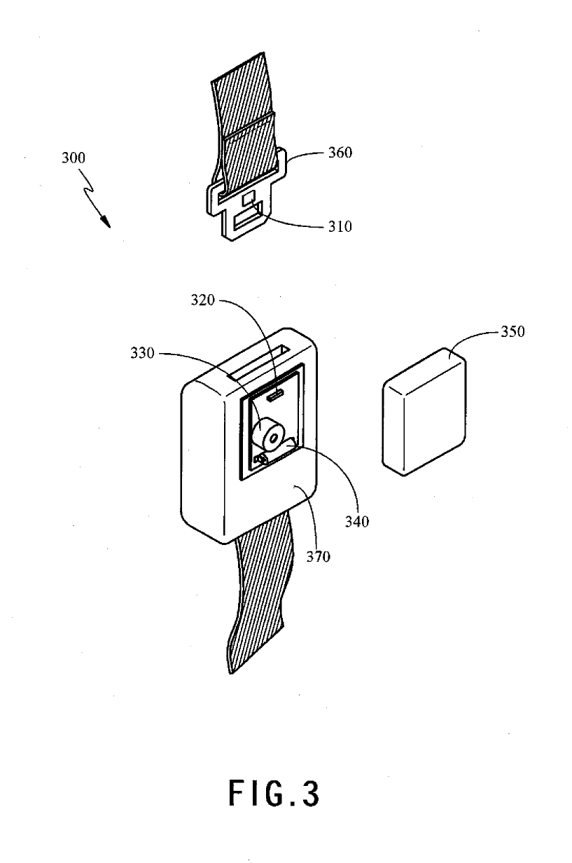

Referring to FIG. 3, it is an illustration of how the provided warning device 300 is used with a vehicle safety belt buckle set. As shown, in another preferred example of the above embodiment, the provided warning device 300 comprises a magnetic element 310 installed on a first buckle member 360 of the buckle set, and a magnetically-activated control element 320, a warning member 330, a power supply member 340 and a lid 350 installed on a second buckle member 370 of the buckle set. The power supply member 340 provides power to the provided warning device 300, and the lid 350 provides protection for the magnetically-activated control element 320, the warning member 330 and the power supply member 340.

When the first buckle member 360 and the second buckle member 370 are not engaged, the magnetically-activated control element 320 does not sense the magnetic field produced by the magnetic element 310, therefore the magnetically-activated control element 320 activates the warning member 330 to give off a warning signal which may be in the form of sound, light or combination thereof. On the other hand, when the first buckle member 360 and second buckle member 370 are engaged, the magnetically-activated control element 320 senses the magnetic field produced by the magnetic element 310 and switches off the warning member 330.

There may be two magnetic elements 310 installed on opposite sides of the first buckle member 360 to ensure correct functioning of said warning device 300 regardless of how the first buckle member 360 engages the second buckle member 370.

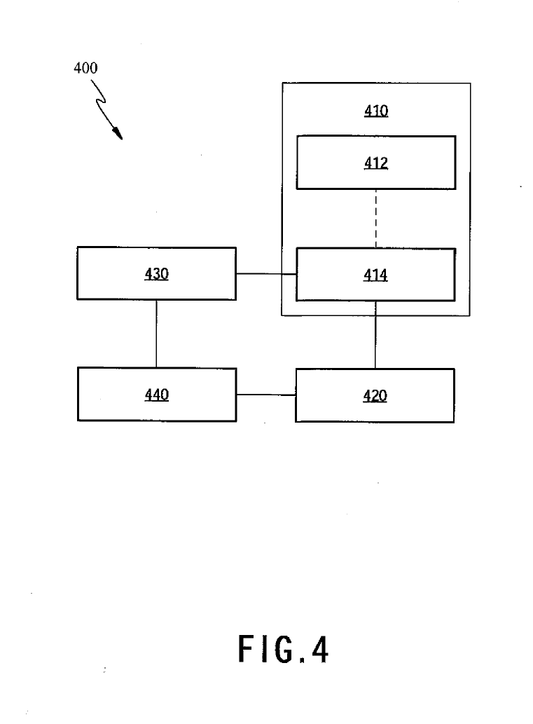

Referring to both FIG. 4 and FIG. 3, in yet another preferred example of the above embodiment, the provided warning device 400 further comprises a vibration sensing member 430 which is electrically coupled to the magnetically-activated control element 414 and the power supply member 440, such that when the first buckle member 360 and the second buckle member 370 are not engaged and the second buckle member 370 is shaken due to movement of the vehicle, the vibration sensing member 430 activates, through the magnetically-activated control element 414, the warning member 420 to give off the warning signal.

On the other hand, when the first buckle member 360 and second buckle member 370 are engaged, the magnetically-activated control element 414 senses the magnetic field produced by the magnetic element 412 and switches off the warning member. In such case, the warning member 420 is not activated if the second buckle member 370 is shaken.

The vibration sensing member 430 is selected from or any combination of the following: at least one ball-rolling switch, at least one spring vibration switch, at least one mercury vibration switch, and any other vibration sensing devices known to those skilled in the art.

In yet another preferred example of the above embodiment, a vehicle safety belt warning device is disclosed, the provided warning device comprises a first magnetic element which is installed on the vehicle door; a second magnetic element which is disposed within the interior of the vehicle and in a position corresponding to the first magnetic element; a warning member which is electrically coupled to the second magnetic element; and a power supply member which is electrically coupled to the warning member, for providing power to the provided warning device.

Either the first and second magnetic element may be a magnetically-activated control device. When the vehicle door is closed, the magnetically-activated control device senses the magnetic field produced by the magnetic element and activates the warning member to give off a warning signal which may be in the form of sound, light or combination thereof.

The warning device may further comprise a control member electrically coupled to the magnetically-activated control device and the warning member for setting up the frequency at which the warning signals are given off and time interval between individual batches of the warning signals. The control member may further comprise a sound recording member electrically coupled to the control member to provide a sound recording function thereby allowing for customized warning signals.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

1. A vehicle safety belt warning device to be used with a vehicle safety belt buckle set which comprises a first buckle member and a second buckle member for engaging with the first buckle member to restrain an occupant in a vehicle for safety purpose, comprising:
a sensing member, comprising a magnetic element installed on said first buckle member and a magnetically-activated control element installed on said second buckle member;
a warning member, electrically coupled to said magnetically-activated control element; and
a power supply member, electrically coupled to said warning member, for providing power to said warning device;
when said first buckle member and said second buckle member are not engaged, said magnetically-activated control element does not sense the magnetic field produced by said magnetic element and said magnetically-activated control element activates the warning member to give off a warning signal; and when said first buckle member and said second buckle member are engaged, said magnetically-activated control element senses the magnetic field produced by said magnetic element and switches off said warning member.

2. The warning device according to claim 1, wherein said sensing member comprises two magnetic elements installed on opposite sides of the first buckle member to ensure correct functioning of said warning device regardless of how said first buckle member engages said second buckle member.

3. The warning device according to claim 1, further comprising a vibration sensing member, electrically coupled to said magnetically-activated control element and said power supply member, such that when said first buckle member and said second buckle member are not engaged and said second buckle member is shaken due to movement of the vehicle, said vibration sensing member activates, through said magnetically-activated control element, said warning member to give off said warning signal, and when said first and second buckle members are engaged, said magnetically-activated control element senses the magnetic field produced by the magnetic element and switches off said warning member, in such case, said warning member is not activated if said second buckle member is shaken.

4. The warning device according to claim 3, wherein said vibration sensing member is selected from or any combination of the following: ball-rolling switch, spring vibration switch, and mercury vibration switch.

5. The warning device according to claim 1, further comprising a control member, electrically coupled to said magnetically-activated control element and said warning member, for setting up the frequency at which said warning signals are given off and time interval between individual batches of said warning signals.

6. The warning device according to claim 5, further comprising a sound recording member, wherein said sound recording member is electrically coupled to said control member.

7. The warning device according to claim 1, wherein said warning signal is in the form of sound, light, or combination thereof.

8. A vehicle safety belt warning device, comprising:
a first magnetic element, installed on the vehicle door;
a second magnetic element, disposed within the interior of the vehicle and in a position corresponding to said first magnetic element;
a warning member, electrically coupled to said second magnetic element; and
a power supply member which is electrically coupled to said warning member, for providing power to said warning device;
when the vehicle door is closed, said second magnetic element senses the magnetic field produced by said first magnetic element and activates said warning member to give off a warning signal.

9. The warning device according to claim 8, wherein said first magnetic element is a magnetically-activated control device.

10. The warning device according to claim 8, wherein said second magnetic element is a magnetically-activated control device.

11. The warning device according to claim 9, further comprising a control member, electrically coupled to said magnetically-activated control device and said warning member, for setting up the frequency at which said warning signals are given off and time interval between individual batches of said warning signals.

12. The warning device according to claim 10, further comprising a control member, electrically coupled to said magnetically-activated control device and said warning member, for setting up the frequency at which said warning signals are given off and time interval between individual batches of said warning signals.

13. The warning device according to claim 11, further comprising a sound recording member, wherein said sound recording member is electrically coupled to said control member.

14. The warning device according to claim 12, further comprising a sound recording member, wherein said sound recording member is electrically coupled to said control member.

15. The warning device according to claim 8, wherein said warning signal is in the form of sound, light, or combination thereof.
